(19) United States
(12) Patent Application Publication
(10) Pub. No.: US 2024/0078606 A1
(43) Pub. Date: Mar. 7, 2024

(54) METHOD AND SYSTEM FOR PERSONAL FINANCIAL PLANNING BY ARTIFICIAL INTELLIGENCE SEARCH

(71) Applicant: JPMorgan Chase Bank, N.A., New York, NY (US)

(72) Inventors: Alberto POZANCO, Madrid (ES); Kassiani PAPASOTIRIOU, New York, NY (US); Daniel BORRAJO, Madrid (ES); Andrea STEFANUCCI, Hoboken, NJ (US); Nicolas MARCHESOTTI, London (GB); Jessica STADDON, Redwood City, CA (US); Manuela VELOSO, New York, NY (US)

(73) Assignee: JPMorgan Chase Bank, N.A., New York, NY (US)

(21) Appl. No.: 17/939,433

(22) Filed: Sep. 7, 2022

(51) Int. Cl. G06Q 40/06

(52) U.S. Cl. CPC G06Q 40/06

(57) ABSTRACT

A method and a computing apparatus for generating a personal financial plan are provided. The method includes: receiving a first input that includes information about an initial financial state of an individual person; receiving a second input that includes information about a goal financial state of the individual person; receiving a third input about financial habits of the individual person; defining a set of available user actions, each respective available user action being assigned a corresponding probability that indicates a likelihood that the individual person successfully performs the respective available user action; determining, based on the defined set of available user actions and heuristics designed to maximize a likelihood of execution, proposed sequences of potential user actions by which the goal financial state is achievable; and calculating, for each proposed sequence, a respective likelihood score that indicates a corresponding feasibility of a successful completion thereof.

### BACKGROUND

### 1. Field of the Disclosure

This technology generally relates to methods and systems for personal financial planning, and more particularly to methods and systems for providing an automated personal financial planning tool that uses a heuristic search functionality to increase a likelihood of a financial plan being executed by an individual based on the financial status and habits of the individual.

### 1. BACKGROUND INFORMATION

Setting financial goals and planning ahead plays a significant role in ensuring financial health for an individual or a household. Personal finance planning activities include managing monetary resources through expenditure, investments, and savings, while considering various life events, risks and goals. The benefits of financial planning have been studied and quantified using economic well-being indicators in both empirical and theoretical settings.

The most common way of seeking financial advice is by consulting a personal finance professional who can help clients make decisions about investments, budgeting or other courses of action to achieve their goals. Such services are often very expensive and thus inaccessible to a lot of people. Alternatives to speaking to an advisor include personal finance assessment tools and questionnaires which offer semipersonalized advice to users based on their input. However, these tools fail to recommend actionable points of advice on a more personal and detailed level.

Previous technical methods of financial planning include expert systems which try to mimic the knowledge and experience of a human experts. The systems collect detailed user information regarding an individual's financial state and consists of a rules base to produce possible solutions to a goal. Other approaches have used rule-based approaches based on different metrics and definitions on financial well-being. The main weakness of these approaches is that they do not provide flexible, detailed, and personalized solutions and do not take into account the feasibility of the recommended plans.

Accordingly, there is a need for a mechanism for providing an automated personal financial planning tool that uses a heuristic search functionality to increase a likelihood of a financial plan being executed by an individual based on the financial status and habits of the individual.

### SUMMARY

The present disclosure, through one or more of its various aspects, embodiments, and/or specific features or sub-components, provides, inter alia, various systems, servers, devices, methods, media, programs, and platforms for providing an automated personal financial planning tool that uses a heuristic search functionality to increase a likelihood of a financial plan being executed by an individual based on the financial status and habits of the individual.

According to an aspect of the present disclosure, a method for generating a personal financial plan is provided. The method is implemented by at least one processor. The method includes: receiving, by the at least one processor, a first input that includes information that relates to an initial financial state of an individual person; receiving, by the at least one processor, a second input that includes information that relates to a goal financial state of the individual person; receiving, by the at least one processor, a third input that includes information that relates to at least one financial habit of the individual person; defining, by the at least one processor based on the first input, the second input, and the third input, a set of available user actions, each respective available user action being assigned a corresponding probability that indicates a likelihood that the individual person successfully performs the respective available user action; determining, by the at least one processor based on the defined set of available user actions, at least one proposed sequence of potential user actions by which the goal financial state is achievable; and calculating, by the at least one processor for each of the at least one proposed sequence of potential user actions, a respective likelihood score that indicates a corresponding feasibility of a successful completion of the at least one proposed sequence of potential user actions.

The first input may include a time step, an amount of income per time step, an amount of discretionary expense per time step, an amount of fixed expense per time step, and an account balance.

The second input may include an aspirational account balance and a time horizon.

The set of available user actions may include a first subset of income increases having first predetermined percentages and a second subset of discretionary expense decreases having second predetermined percentages.

The calculating of the likelihood score may include computing a first heuristic that indicates a minimum cost that is associated with a cheapest one from among the at least one proposed sequence of potential user actions.

The calculating of the likelihood score may further include computing a second heuristic that indicates a second respective cost that is associated with a corresponding one from among the at least one proposed sequence of potential user actions. The second heuristic may be admissible with respect to a predetermined maximum estimate of a cost of achieving the goal financial state.

The calculating of the likelihood score may further include computing a third heuristic that indicates a third respective cost that is associated with a corresponding one from among the at least one proposed sequence of potential user actions. The third heuristic may be inadmissible with respect to the predetermined maximum estimate of the cost of achieving the goal financial state.

Each of the computing of the first heuristic, the computing of the second heuristic, and the computing of the third heuristic may include applying an artificial intelligence (AI)-based algorithm to the first input and the second input.

According to another aspect of the present disclosure, a computing apparatus for generating a personal financial plan is provided. The computing apparatus includes a processor; a memory; and a communication interface coupled to each of the processor and the memory. The processor is configured to: receive, via the communication interface, a first input that includes information that relates to an initial financial state of an individual person; receive, via the communication interface, a second input that includes information that relates to a goal financial state of the individual person; receive, via the communication interface, a third input that includes information that relates to at least one financial habit of the individual person; define, based on the first input, the second input, and the third input, a set of available user actions, each respective available user action being assigned a corresponding probability that indicates a likelihood that the individual person successfully performs the respective available user action; determine, based on the defined set of available user actions, at least one proposed sequence of potential user actions by which the goal financial state is achievable; and calculate, for each of the at least one proposed sequence of potential user actions, a respective likelihood score that indicates a corresponding feasibility of a successful completion of the at least one proposed sequence of potential user actions.

The first input may include a time step, an amount of income per time step, an amount of discretionary expense per time step, an amount of fixed expense per time step, and an account balance.

The second input may include an aspirational account balance and a time horizon.

The set of available user actions may include a first subset of income increases having first predetermined percentages and a second subset of discretionary expense decreases having second predetermined percentages.

The processor may be further configured to compute a first heuristic that indicates a minimum cost that is associated with a cheapest one from among the at least one proposed sequence of potential user actions.

The processor may be further configured to compute a second heuristic that indicates a second respective cost that is associated with a corresponding one from among the at least one proposed sequence of potential user actions. The second heuristic may be admissible with respect to a predetermined maximum estimate of a cost of achieving the goal financial state.

The processor may be further configured to compute a third heuristic that indicates a third respective cost that is associated with a corresponding one from among the at least one proposed sequence of potential user actions. The third heuristic may be inadmissible with respect to the predetermined maximum estimate of the cost of achieving the goal financial state.

The processor may be further configured to compute each of the first heuristic, the second heuristic, and the third heuristic by applying an artificial intelligence (AI)-based algorithm to the first input and the second input.

According to yet another aspect of the present disclosure, a non-transitory computer readable storage medium storing instructions for generating a personal financial plan is provided. The storage medium includes executable code which, when executed by a processor, causes the processor to: receive a first input that includes information that relates to an initial financial state of an individual person; receive a second input that includes information that relates to a goal financial state of the individual person; receive a third input that includes information that relates to at least one financial habit of the individual person; define, based on the first input, the second input, and the third input, a set of available user actions, each respective available user action being assigned a corresponding probability that indicates a likelihood that the individual person successfully performs the respective available user action; determine, based on the defined set of available user actions, at least one proposed sequence of potential user actions by which the goal financial state is achievable; and calculate, for each of the at least one proposed sequence of potential user actions, a respective likelihood score that indicates a corresponding feasibility of a successful completion of the at least one proposed sequence of potential user actions.

The first input may include a time step, an amount of income per time step, an amount of discretionary expense per time step, an amount of fixed expense per time step, and an account balance.

The second input may include an aspirational account balance and a time horizon.

The set of available user actions may include a first subset of income increases having first predetermined percentages and a second subset of discretionary expense decreases having second predetermined percentages.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing an automated personal financial planning tool that uses a heuristic search functionality to increase a likelihood of a financial plan being executed by an individual based on the financial status and habits of the individual.

FIG. 4 is a flowchart of an exemplary process for implementing a method for providing an automated personal financial planning tool that uses a heuristic search functionality to increase a likelihood of a financial plan being executed by an individual based on the financial status and habits of the individual.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

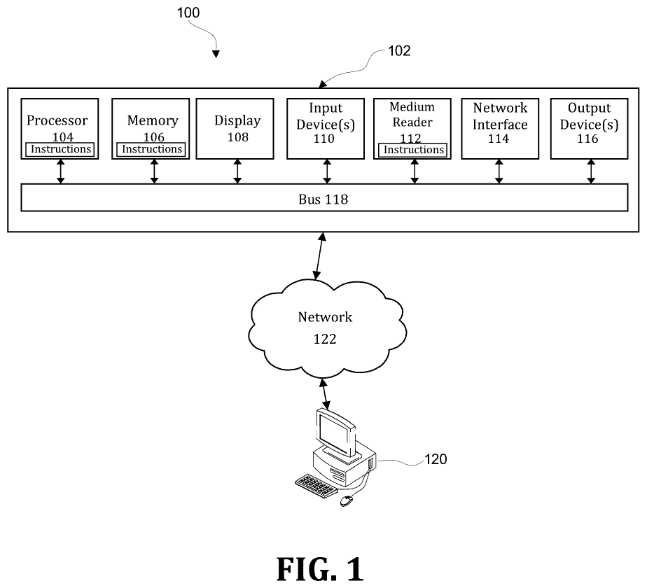

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing an automated personal financial planning tool that uses a heuristic search functionality to increase a likelihood of a financial plan being executed by an individual based on the financial status and habits of the individual.

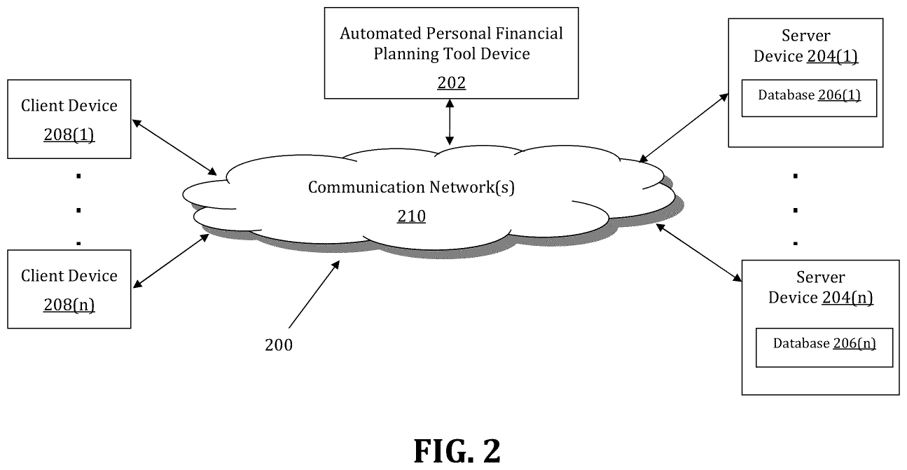

Referring to FIG. 2, a schematic of an exemplary network environment 200 for implementing a method for providing an automated personal financial planning tool that uses a heuristic search functionality to increase a likelihood of a financial plan being executed by an individual based on the financial status and habits of the individual is illustrated. In an exemplary embodiment, the method is executable on any networked computer platform, such as, for example, a personal computer (PC).

The method for providing an automated personal financial planning tool that uses a heuristic search functionality to increase a likelihood of a financial plan being executed by an individual based on the financial status and habits of the individual may be implemented by an Automated Personal Financial Planning Tool (APFPT) device 202. The APFPT device 202 may be the same or similar to the computer system 102 as described with respect to FIG. 1. The APFPT device 202 may store one or more applications that can include executable instructions that, when executed by the APFPT device 202, cause the APFPT device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the APFPT device 202 itself, may be located in virtual server(s) running in a cloud-based computing environment rather than being tied to one or more specific physical network computing devices. Also, the application(s) may be running in one or more virtual machines (VMs) executing on the APFPT device 202. Additionally, in one or more embodiments of this technology, virtual machine(s) running on the APFPT device 202 may be managed or supervised by a hypervisor.

In the network environment 200 of FIG. 2, the APFPT device 202 is coupled to a plurality of server devices 204(1)-204(n) that hosts a plurality of databases 206(1)-206(n), and also to a plurality of client devices 208(1)-208(n) via communication network(s) 210. A communication interface of the APFPT device 202, such as the network interface 114 of the computer system 102 of FIG. 1, operatively couples and communicates between the APFPT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the APFPT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and APFPT devices that efficiently implement a method for providing an automated personal financial planning tool that uses a heuristic search functionality to increase a likelihood of a financial plan being executed by an individual based on the financial status and habits of the individual.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The APFPT device 202 may be a standalone device or integrated with one or more other devices or apparatuses, such as one or more of the server devices 204(1)-204(n), for example. In one particular example, the APFPT device 202 may include or be hosted by one of the server devices 204(1)-204(n), and other arrangements are also possible. Moreover, one or more of the devices of the APFPT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the APFPT device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to user-specific personal financial information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the APFPT device 202 via communication network(s) 210. Accordingly, the client devices 208(1)-208(n) may be mobile computing devices, desktop computing devices, virtual computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the APFPT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the APFPT device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the APFPT device 202, the server devices 204(1)-204(n), or the client devices 208(1)-208(n), for example, may be configured to operate as virtual instances on the same physical machine. In other words, one or more of the APFPT device 202, the server devices 204(1)-204(n), or the client devices 208(1)-208(n) may operate on the same physical device rather than as separate devices communicating through communication network(s) 210. Additionally, there may be more or fewer APFPT devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

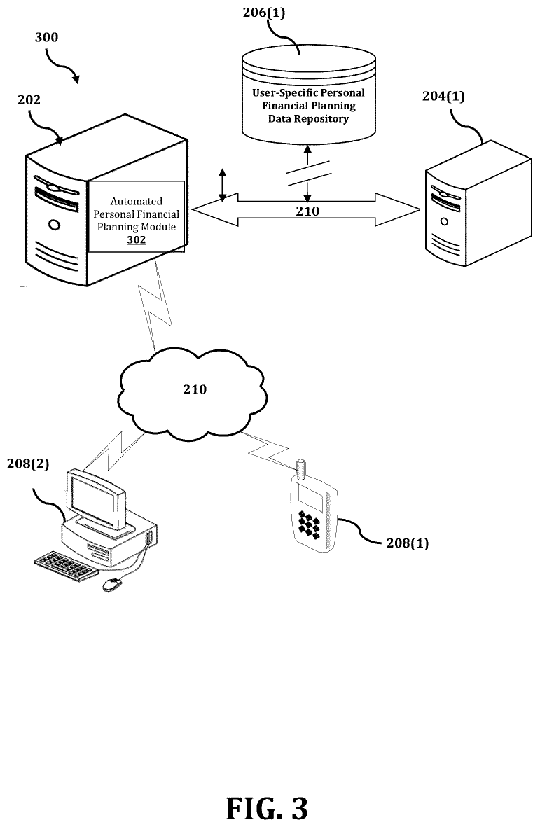

The APFPT device 202 is described and illustrated in FIG. 3 as including an automated personal financial planning module 302, although it may include other rules, policies, modules, databases, or applications, for example. As will be described below, the automated personal financial planning module 302 is configured to implement a method for providing an automated personal financial planning tool that uses a heuristic search functionality to increase a likelihood of a financial plan being executed by an individual based on the financial status and habits of the individual.

An exemplary process 300 for implementing a mechanism for providing an automated personal financial planning tool that uses a heuristic search functionality to increase a likelihood of a financial plan being executed by an individual based on the financial status and habits of the individual by utilizing the network environment of FIG. 2 is illustrated as being executed in FIG. 3. Specifically, a first client device 208(1) and a second client device 208(2) are illustrated as being in communication with APFPT device 202. In this regard, the first client device 208(1) and the second client device 208(2) may be “clients” of the APFPT device 202 and are described herein as such. Nevertheless, it is to be known and understood that the first client device 208(1) and/or the second client device 208(2) need not necessarily be “clients” of the APFPT device 202, or any entity described in association therewith herein. Any additional or alternative relationship may exist between either or both of the first client device 208(1) and the second client device 208(2) and the APFPT device 202, or no relationship may exist.

Further, APFPT device 202 is illustrated as being able to access a user-specific personal financial planning data repository 206(1). The automated personal financial planning module 302 may be configured to access this database for implementing a method for providing an automated personal financial planning tool that uses a heuristic search functionality to increase a likelihood of a financial plan being executed by an individual based on the financial status and habits of the individual.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the APFPT device 202 via broadband or cellular communication. Of course, these embodiments are merely exemplary and are not limiting or exhaustive.

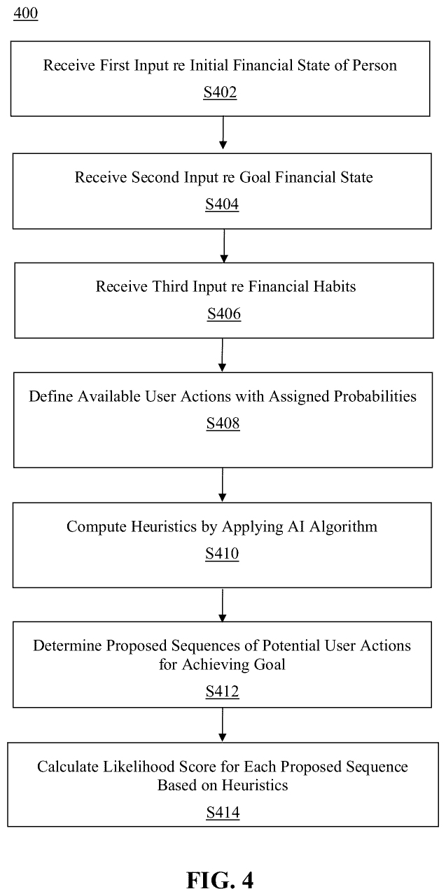

Upon being started, the automated personal financial planning module 302 executes a process for providing an automated personal financial planning tool that uses a heuristic search functionality to increase a likelihood of a financial plan being executed by an individual based on the financial status and habits of the individual. An exemplary process for providing an automated personal financial planning tool that uses a heuristic search functionality to increase a likelihood of a financial plan being executed by an individual based on the financial status and habits of the individual is generally indicated at flowchart 400 in FIG. 4.

In process 400 of FIG. 4, at step S402, the automated personal financial planning module 302 receives a first input that includes information that relates to an initial financial state of an individual person. In an exemplary embodiment, the first input includes a time step, such as a specific number of months; an amount of income per time step; an amount of discretionary expense per time step; an amount of fixed expense per time step; and an account balance.

At step S404, the automated personal financial planning module 302 receives a second input that includes information that relates to a goal financial state of the individual person. In an exemplary embodiment, the second input includes an aspirational account balance and a time horizon. For example, if the current account balance is equal to X, then the aspirational account balance may be equal to 2X or 3X or some multiplier of X, and the time horizon may be one year or five years or any other suitable time frame. Then, at step S406, the automated personal financial planning module 302 receives a third input that includes information that relates to financial habits of the individual person. For example, the person may have an expectation that his/her income may increase by some amount within the next few months, or that his/her discretionary spending may change in some particular manner within the next few months.

At step S408, the automated personal financial planning module 302 defines a set of available user actions that represent incremental ways for the individual person to make progress toward achieving the goal financial state. In an exemplary embodiment, each available user action is assigned a probability that indicates a likelihood that the individual person will successfully perform the action. The probability assignments may be at least partially dependent upon the third input received in step S406.

In an exemplary embodiment, the set of available user actions includes a first subset of income increases per time step having first percentages and a second subset of discretionary expense decreases per time step having second percentages. For example, assuming that the time step is equal to t (e.g., one month, two months, three months, six months, twelve months, or any other suitable amount of time), the first subset of income increases may include an income increase of 0%, an income increase of 5%, an income increase of 10%, an income increase of 15%, an income increase of 20%, an income increase of 25%, an income increase of 50%, and an income increase of 100%. In addition, each available income increase is assigned a probability that indicates the likelihood that this action will be successfully achieved. Thus, in this example, the income increase of 0% may be assigned a probability of 1.0; the income increase of 5% may be assigned a probability of 0.9; then income increase of 10% may be assigned a probability of 0.8; the income increase of 15% may be assigned a probability of 0.75; the income increase of 20% may be assigned a probability of 0.6; the income increase of 25% may be assigned a probability of 0.5; the income increase of 50% may be assigned a probability of 0.2; and the income increase of 100% may be assigned a probability of 0.05.

Continuing with this example, the second subset of discretionary expense decreases may include an expense decrease of 0%, an expense decrease of 5%, an expense decrease of 10%, an expense decrease of 15%, an expense decrease of 20%, and an expense decrease of 25%. In addition, each available discretionary expense decrease is assigned a probability that indicates the likelihood that this action will be successfully achieved. Thus, in this example, the expense decrease of 0% may be assigned a probability of 1.0; the expense decrease of 5% may be assigned a probability of 0.9; then expense decrease of 10% may be assigned a probability of 0.8; the expense decrease of 15% may be assigned a probability of 0.65; the expense decrease of 20% may be assigned a probability of 0.45; and the expense decrease of 25% may be assigned a probability of 0.2.

At step S408, the automated personal financial planning module 302 computes a set of heuristics that are useful for narrowing the scope of potential proposed sequences of potential user actions in a manner that focuses on sequences that tend to be more feasible and realistic and therefore have a higher likelihood of success. In an exemplary embodiment, the computation of the set of heuristics is performed by applying an artificial intelligence (AI)-based algorithm that uses the initial financial state information, the goal financial state information, and the set of available user actions together with their assigned probabilities as inputs thereto.

In an exemplary embodiment, the AI-based algorithm is designed to calculate, for any particular proposed sequence of potential user actions, a respective cost for that particular sequence. Then, the set of heuristics to be computed includes a first heuristic that indicates a minimum cost that is associated with a cheapest possible proposed sequence of potential user actions; a second heuristic that indicates a second cost that is associated with a particular proposed sequence of potential user actions and that qualifies as being an “admissible” heuristic by virtue of being less than or equal to a predetermined maximum estimate of a cost of achieving the goal financial state; and a third heuristic that is associated with another particular proposed sequence of potential user actions and that qualifies as being an “inadmissible” heuristic with respect to the predetermined maximum cost estimate.

At step S410, the automated personal financial planning module 302 determines a set of proposed sequences of potential user actions by which the goal financial state is achievable. In an exemplary embodiment, the automate personal financial planning module 302 uses the heuristics computed in step S408 to narrow the scope of proposed sequences in order to maximize a likelihood that the proposed sequences will be executed by the individual person. In an exemplary embodiment, such a proposed sequence includes some combination of income increases per time step and discretionary expense decreases per time step. For example, the automated personal financial planning module may determine that there are at least three different ways to achieve the goal financial state: first, by a series of 5% income increases and 15% expense decreases; second, by a series of 10% income increases and 5% expense decreases; and third, by an income increase of 50% together with zero expense decrease. As another example, a proposed sequence may include other specific types of potential user actions, such as investments in financial instruments such as stocks and bonds, specific types of expenditures such as projected travel expenses, projected dining expenses, projected expenses for large purchases such as real estate or automobile, and/or any other suitable type of potential user action.

At step S412, the automated personal financial planning module 302 calculates a likelihood score that indicates, for each proposed sequence of potential user actions, a corresponding feasibility of a successful completion of that particular sequence.

In an exemplary embodiment, a Personal Finance Planning Tool (PFPT) which offers financial advice at the individual level is disclosed. The PFPT allows users to define both long-term and short-term financial goals and recommends actions to successfully achieve them based on their financial habits. This problem is modeled from a search perspective by defining states, actions and goals and applying domain-independent automated planning and domain-dependent heuristic search to recommend plans that maximize the likelihood of being executed based on the individual financial habits.

In an exemplary embodiment, a planning task that is augmented with numeric variables is defined as follows:

Definition 1. A numeric planning task is a tuple Π=(F, A, I, G), where F is a set of boolean and numeric variables, A is a set of actions, I⊆F is the initial state and G ⊆F is a set of goals.

S denotes the set of all states of the planning task II. A full state s E S is a valuation of all the variables in F; including a boolean value for all the boolean variables and a numeric value for the numeric variables.

Each action a∈A is defined in terms of its preconditions (pre(a)) and effects (eff(a)). Effects can set to true the value of a boolean variable (add effects, add(a)), set to false the value of a boolean variable (del effects, del(a)), and change the value of a numeric variable (numeric effects, num(a)). Action execution is defined as a function γ: S,A→S′; that is, this function defines the state that results of applying an action in a given state. In an exemplary embodiment, the function is defined as γ(s,a)=(s\del(a))Uadd(a) if pre(a)⊆s when only boolean variables are considered. When using numeric variables, γ also changes the values of the numeric variables (if any) in num(a), according to what the action specifies; thereby increasing or decreasing the value of a numeric variable or assigning a new value to a numeric variable. If the preconditions do not hold in s, the state does not change.

The solution of a planning task is called a plan, and a plan is a sequence of instantiated actions that allows the system to transit from the initial state I to a state s where goals are true. Therefore, a plan π=(a₁, a₂, . . . , aₙ) solves a planning task Π (valid plan) if and only if ∀aᵢ ∈π, aᵢ∈A, and G⊆γ( . . . γ(γ(I, a₁), a₂) . . . ), aₙ). In case the cost is relevant, each action can have an associated cost, c(aᵢ), ∀aᵢ∈A and the cost of the plan is defined as the sum of the costs of its actions: c(π)=^{P}ᵢc(aᵢ), ∀aᵢ∈π. A plan with minimal cost is called optimal.

PFPT Problem Definition: In an exemplary embodiment, an objective is to find realistic financial plans that allow users to go from their current financial state to their goal financial state. A financial state may defined as follows:

Definition 2. A financial state is a tuple s=(t, Inc, DExp, FExp, B), where: t∈N is a time step; Inc∈R is the income per time step; DExp∈R are the discretionary expenses per time step; FExp∈R are the fixed expenses per time step; and B=(B\hat{ }+Inc−DExp−FExp) is the account balance, where B\hat{ } is the account balance of s's parent at t−1.

In an exemplary embodiment, the initial financial state is fully specified, while the goal financial state may be partially specified. For example, the goal state could specify that the balance at a given time step should be higher than a given quantity.

At each time step, some actions can be applied in order to change the financial state into another one. In an exemplary embodiment, two types of actions are defined: income increases and discretionary expenses decreases. It is assumed that the fixed expenses cannot be changed, or are highly unlikely to be changed. Actions might produce changes in the financial state. For example, an income increase of 20% in state sₜ will result in a new state at the next time step sₜ₊₁ with income Inc(sₜ₊₁)=1.2×Inc(sₜ). In addition to these effects over the financial state, each action has associated a likelihood score, which is a real number between 0.0 and 1.0 inclusive that reflects how feasible or probable it is that a user executes the action. This likelihood score can be assigned by users or inferred from their financial habits. For example, increasing the income by 0% will have a higher likelihood score than increasing the income by 20%, since the former is an easier or more feasible action than the latter. Table 1 summarizes a potential set of actions together with their effects to the financial state and their likelihood scores.

Income increase and discretionary expenses decrease actions can be combined to generate joint actions. Assuming the actions listed in Table 1 represent a complete set of available user actions, there are nine (9) possible joint actions that can be applied at each time step, i.e., [Increase Inc 10%, Decrease DExp 0%], [Increase Inc 20%, Decrease DExp 10%], etc. A plan π solves this problem optimally if it achieves the financial goal state by maximizing the likelihood product of its actions. Equation 1 below presents a formal expression of this statement:

$$max {\prod }_{a ∈ π} likelihood ( a ) \qquad ( 1 )$$

There are two obstacles when trying to use search algorithms to optimally solve the problem as defined in Expression 1: (1) plan optimality is defined as a product, while search algorithms ordering functions are typically additive; and (2) plan optimality is defined as a maximization task (i.e., to maximize likelihood), while most search algorithms aim to minimize a given function. In an exemplary embodiment, in order to overcome the first problem, the logarithm of each action's likelihood score is computed in order to transform a multiplication operation into an addition operation. To overcome the second problem, the maximization task is transformed into a minimization task by subtracting the logarithm of the likelihood score from one. By performing these two transformations, the following additive cost function that search algorithms can minimize is provided as Equation 2:

c(a)=1−log(likelihood(a)) (2)

Given a plan π and its cost c(π), its likelihood score may be computed by applying the following operation as expressed in Equation 3:

likelihood(π)=exp(−(c(π)−|π|)) (3)

Automated Planning Approach: In an exemplary embodiment, a first approach uses automated planning models and planners to generate solutions. The domain is composed of actions that model the actions described in Table 1.

TABLE 1
Summary of Available User Actions

| Action | Effect | Likelihood |
|---|---|---|
| Increase Income by 0% | — | 1.0 |
| Increase Income by 10% | Inc(_{S}_{ₜ₊₁}) = 1.1 × Inc(_{S}_{ₜ}) | 0.8 |
| Increase Income by 20% | Inc(_{S}_{ₜ₊₁}) = 1.2 × Inc(_{S}_{ₜ}) | 0.6 |
| Decrease Discretionary | — | 1 |
| Expenses by 0% | | |
| Decrease Discretionary | DExp(_{S}_{ₜ₊₁}) = 0.9 × DExp(_{S}_{ₜ}) | 0.9 |
| Expenses by 10% | | |
| Decrease Discretionary | DExp(_{S}_{ₜ₊₁}) = 0.8 × DExp(_{S}_{ₜ}) | 0.8 |
| Expenses by 20% | | |

In an exemplary embodiment, at each time step, the execution of only one action of each kind is allowed: modify income or modify expenses. This action is the only one defined to modify income and summarizes all possible increase operations over income. The parameters of the action are a time step and a percentage of increase. Because there is no need for complex temporal reasoning, discrete temporal problems are considered, and therefore time is modeled as a sequence of time steps. Percentages are also represented as discrete amounts and are defined in the problem description. In the case of the percentages defined in Table 1, there are defined three objects of type percentage in the problem for the income (0, 10 and 20) and another three for modifying the expenses (also 0, 10 and 20). The reason to separate income percentages from expenses percentages is that there is also a need to define their corresponding likelihoods (i.e., predicate likelihoods), which have different values. For instance, the likelihood of increasing income by 20% is 0.6, while the likelihood of decreasing the expenses by 20% is 0.8.

The preconditions of the actions are that although the model is currently at a given time step, the income has not yet been updated at that time step. The expected effects are that the income will increase based on the percentage, the balance is increased with the new income, and the total cost is updated. The cost is as defined in Equation 2 above. Apart from the increase in income and decrease in expenses, the domain also includes a move-time action that progresses time.

The problem description contains objects related to the set of time steps and the percentages. If the user sets as a goal financial state to have a balance x at time step T, the problem will be automatically generated with all the time steps between zero (0) and T. The initial state defines the initial income, balance, and expenses, as well as the likelihoods of each percentage, the initial total cost of zero (0), the initial time step of zero (0) and the needed next predicates to connect in sequence all the time steps. The goal description is compiled from the user goals, as for instance, the balance being greater than a given value at a given time step.

The plans are proposed sequences of actions that achieve the goals from the initial state. They are comprised of a joint action (income, expenses) at each time step, plus a move-time action to progress to the next time step. As an example, a plan may be as follows:
(increase-income t0 p-inc-0)
(decrease-expenses t0 p-exp-20)
(move-time t0 t1)
(increase-income t1 p-inc-10)
(decrease-expenses t1 p-exp-0)
   that would not increase income and decrease expenses in a 20% in the first time step, and increase income in a 10% and not modify expenses in the second time step.

The main drawback of using planning for solving this task is that it is a numerical planning task. First, there are very few planners that can handle this kind of domain complexity. Second, performing optimal numerical planning is known to be an intractable problem. Thus, in an exemplary embodiment, a search-based solution that allows for a computation of optimal solutions for this task is disclosed below.

Heuristic Search Approach: In an exemplary embodiment, a popular algorithm for optimal search known as A* may be employed to solve this problem in a domain-dependent fashion. A* uses a function ƒ(s)=g(s)+h(s) to order the nodes in the open list. The solutions returned by A* are guaranteed to be optimal if the heuristic h is admissible, i.e., it does not over-estimate the cost of reaching the goal from any state.

The cost of reaching a state s, g(s), is computed by using Equation 2. In order to estimate the cost of reaching the goal from s, h(s), the following domain-dependent heuristics are utilized.

Minimum Cost Action: The first heuristic, referred to hereinafter as Min, is computable by choosing the cost of the cheapest joint action c(a)min and multiplying by the number of remaining time steps: h(s)=c(a)min×(t(G)−t(s)). In this case, the cheapest joint action is to do nothing, i.e., increase the salary by 0% and decrease the discretionary expenses by 0%.

Lemma 1: Min is admissible. Proof: By construction, at each time step, there is no cheaper joint action than c(a)ₘᵢₙ. The result of multiplying the minimum cost by the (t(G)−t(s)) will necessarily be less than or equal h*. Therefore, Min is admissible.

Greedy Heuristic: In an exemplary embodiment, the next heuristic is computable by solving a relaxation of the problem where only the same action can be applied at every time step. In this regard, the number of potential plans is limited to the number of joint actions considered. The procedure that computes the heuristic is outlined in Algorithm 1. The algorithm receives as input the current (s) and goal (G) state, the available actions (A), and a parameter that indicates whether or not the heuristic is admissible. The algorithm first computes the number of remaining time steps from s (line 2). If the goal state does not specify any time step, this is set to a high number. Then, the actions in A are sorted according to their cost as per Equation 1. Next, the algorithm iterates over the sorted list of actions, executing the given action a from s for the number of remaining steps, yielding a state s′. If the goal is satisfied in s′, the algorithm finishes and returns the heuristic estimate. This heuristic value will depend on the admissibility parameter. If the heuristic is admissible (GHₐ), Algorithm 1 will return the cost of executing that action, c(a).

Algorithm 1: Greedy Heuristic

| Require: s, G, A, Admissible | |
|---|---|
| Ensure: GH | |
| 1: | GH ← ∞ |
| 2: | remainingTimeSteps ← t(G) − t(s) |
| 3: | sortedActions ← SORTBYCOST(A) |
| 4: | for a ∈ sortedActions do |
| 5: | s′ ← EXECUTE(remainingTimeSteps,a,s) |
| 6: | if G ⊆ s′ then |
| 7: | if Admissible = True then |
| 8: | GH ← c(a) |
| 9: | else |
| 10: | GH ← c(a) × remainingTimeSteps |
| 11: | return GH |
| 12: | return GH |

Lemma 2. GHₐ is admissible. Proof: Suppose GHₐ returns c(a) and c(a)>h*. This means that there is a solution that only uses actions with a cost less than c(a). If the solution would be using actions whose cost would be greater than c(a), then c(a) would be less than h*, so the assumption would be false. Further, if there would be a solution using only a subset of less costly actions, it would had been found before a, since they are studied from less costly to more costly. Thus, c(a) is less than h*, and it is admissible.

If a more informative but inadmissible heuristic (GHᵢ) is desired, Algorithm 1 returns the cost of executing that action multiplied by the number of remaining steps.

Lemma 3. GHᵢ is inadmissible. Proof: The heuristic value returned by GHᵢ considers executing the cheapest possible action a that reaches the goal (ensured by the sorting of the actions in line 3 and the loop in line 4 in all the remaining time steps. However, reaching the goal state could only require executing a in a subset of the remaining time steps together with some lower cost actions in the other steps. Thus, GHᵢ could return greater values than h* for some state/goal combinations, and therefore, it is inadmissible.

If after iterating over all the possible actions the goal cannot be achieved, Algorithm 1 will return infinity (∞), which means that the goal is not reachable from a.

Heuristics Behavior Example: The following exemplifies how the heuristics work and their accuracy by computing them at the initial state (h(I)) of the following PFPT problem:

I= [symbol] (t=0,Inc=5,DExp=2,FExp=2,B=10 [symbol] ;G= [symbol] t=4,B=17

[symbol]

The optimal solution to this problem has a cost of 8.43 (h*(I)). The minimum cost action heuristic Min returns the cost of the cheapest action multiplied by the number of remaining time steps. The cheapest joint action is to Increase Inc 0% and Decrease DExp 20%, and has an associated cost of 2. After multiplying this cost by the four remaining time steps, Min will return a cost of 8, which is a lower bound on h*(I). The greedy algorithm returns that [Increase Inc 0%, Decrease DExp 20%] is the cheapest joint action that can be subsequently executed from I in the remaining time steps to achieve the goal. This joint action has an associated cost of 2.22. Therefore, GHₐ will return that cost, which is a lower bound on h*(I), while GHᵢ will return 2.22×4=8.88, which is an upper bound on h*(I).

Accordingly, with this technology, an optimized process for providing an automated personal financial planning tool that uses a heuristic search functionality to increase a likelihood of a financial plan being executed by an individual based on the financial status and habits of the individual is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a personal financial plan, the method being implemented by at least one processor, the method comprising:
receiving, by the at least one processor, a first input that includes information that relates to an initial financial state of an individual person;
receiving, by the at least one processor, a second input that includes information that relates to a goal financial state of the individual person;
receiving, by the at least one processor, a third input that includes information that relates to at least one financial habit of the individual person;
defining, by the at least one processor based on the first input, the second input and the third input, a set of available user actions, each respective available user action being assigned a corresponding probability that indicates a likelihood that the individual person successfully performs the respective available user action;
determining, by the at least one processor based on the defined set of available user actions, at least one proposed sequence of potential user actions by which the goal financial state is achievable; and
calculating, by the at least one processor for each of the at least one proposed sequence of potential user actions, a respective likelihood score that indicates a corresponding feasibility of a successful completion of the at least one proposed sequence of potential user actions.

2. The method of claim 1, wherein the first input includes a time step, an amount of income per time step, an amount of discretionary expense per time step, an amount of fixed expense per time step, and an account balance.

3. The method of claim 2, wherein the second input includes an aspirational account balance and a time horizon.

4. The method of claim 1, wherein the set of available user actions includes a first subset of income increases having first predetermined percentages and a second subset of discretionary expense decreases having second predetermined percentages.

5. The method of claim 1, further comprising computing a first heuristic that indicates a minimum cost that is associated with a cheapest one from among the at least one proposed sequence of potential user actions.

6. The method of claim 5, further comprising computing a second heuristic that indicates a second respective cost that is associated with a corresponding one from among the at least one proposed sequence of potential user actions, wherein the second heuristic is admissible with respect to a predetermined maximum estimate of a cost of achieving the goal financial state.

7. The method of claim 6, further comprising:
computing a third heuristic that indicates a third respective cost that is associated with a corresponding one from among the at least one proposed sequence of potential user actions, wherein the third heuristic is inadmissible with respect to the predetermined maximum estimate of the cost of achieving the goal financial state; and
using the first heuristic, the second heuristic, and the third heuristic to narrow a scope of the at least one proposed sequence of user actions.

8. The method of claim 7, wherein each of the computing of the first heuristic, the computing of the second heuristic, and the computing of the third heuristic comprises applying an artificial intelligence (AI)-based algorithm to the first input and the second input.

9. A computing apparatus for generating a personal financial plan, the computing apparatus comprising:
a processor;
a memory; and
a communication interface coupled to each of the processor and the memory, wherein the processor is configured to:
receive, via the communication interface, a first input that includes information that relates to an initial financial state of an individual person;
receive, via the communication interface, a second input that includes information that relates to a goal financial state of the individual person;
receive, via the communication interface, a third input that includes information that relates to at least one financial habit of the individual person;
define, based on the first input, the second input, and the third input, a set of available user actions, each respective available user action being assigned a corresponding probability that indicates a likelihood that the individual person successfully performs the respective available user action;
determine, based on the defined set of available user actions, at least one proposed sequence of potential user actions by which the goal financial state is achievable; and
calculate, for each of the at least one proposed sequence of potential user actions, a respective likelihood score that indicates a corresponding feasibility of a successful completion of the at least one proposed sequence of potential user actions.

10. The computing apparatus of claim 9, wherein the first input includes a time step, an amount of income per time step, an amount of discretionary expense per time step, an amount of fixed expense per time step, and an account balance.

11. The computing apparatus of claim 10, wherein the second input includes an aspirational account balance and a time horizon.

12. The computing apparatus of claim 9, wherein the set of available user actions includes a first subset of income increases having first predetermined percentages and a second subset of discretionary expense decreases having second predetermined percentages.

13. The computing apparatus of claim 9, wherein the processor is further configured to compute a first heuristic that indicates a minimum cost that is associated with a cheapest one from among the at least one proposed sequence of potential user actions.

14. The computing apparatus of claim 13, wherein the processor is further configured to compute a second heuristic that indicates a second respective cost that is associated with a corresponding one from among the at least one proposed sequence of potential user actions, wherein the second heuristic is admissible with respect to a predetermined maximum estimate of a cost of achieving the goal financial state.

15. The computing apparatus of claim 14, wherein the processor is further configured to:
compute a third heuristic that indicates a third respective cost that is associated with a corresponding one from among the at least one proposed sequence of potential user actions, wherein the third heuristic is inadmissible with respect to the predetermined maximum estimate of the cost of achieving the goal financial state; and
use the first heuristic, the second heuristic, and the third heuristic to narrow a scope of the at least one proposed sequence of user actions.

16. The computing apparatus of claim 15, wherein the processor is further configured to compute each of the first heuristic, the second heuristic, and the third heuristic by applying an artificial intelligence (AI)-based algorithm to the first input and the second input.

17. A non-transitory computer readable storage medium storing instructions for generating a personal financial plan, the storage medium comprising executable code which, when executed by a processor, causes the processor to:
receive a first input that includes information that relates to an initial financial state of an individual person;
receive a second input that includes information that relates to a goal financial state of the individual person;
receive a third input that includes information that relates to at least one financial habit of the individual person;
define, based on the first input, the second input, and the third input, a set of available user actions, each respective available user action being assigned a corresponding probability that indicates a likelihood that the individual person successfully performs the respective available user action;
determine, based on the defined set of available user actions, at least one proposed sequence of potential user actions by which the goal financial state is achievable; and
calculate, for each of the at least one proposed sequence of potential user actions, a respective likelihood score that indicates a corresponding feasibility of a successful completion of the at least one proposed sequence of potential user actions.

18. The storage medium of claim 17, wherein the first input includes a time step, an amount of income per time step, an amount of discretionary expense per time step, an amount of fixed expense per time step, and an account balance.

19. The storage medium of claim 18, wherein the second input includes an aspirational account balance and a time horizon.

20. The storage medium of claim 17, wherein the set of available user actions includes a first subset of income increases having first predetermined percentages and a second subset of discretionary expense decreases having second predetermined percentages.
